(19) United States
(12) Patent Application Publication
(10) Pub. No.: US 2009/0245162 A1
(43) Pub. Date: Oct. 1, 2009

(54) Communication Systems

(75) Inventors: Michael John Beems Hart, London (GB); Juefeng Zhou, Surrey (GB)

Correspondence Address: BAKER BOTTS L.L.P., 2001 ROSS AVENUE, SUITE 600, DALLAS, TX, 75201-2980, US

(73) Assignee: FUJITSU LIMITED, KAWASAKI-SHI, KANAGAWA (JP)

(21) Appl. No.: 12/377,629

(22) PCT Filed: Jul. 31, 2007
(86) PCT No.: PCT/GB2007/002904

§ 371 Date: Feb. 16, 2009

(30) Foreign Application Priority Data
Aug. 18, 2006 (GB) 0616475.0

(51) Int. Cl. H04J 1/10; H04B 7/14

(52) U.S. Cl. 370/315; 455/7

(57) ABSTRACT

A method of assessing a potential communication link in a wireless communication system, the system comprising a source apparatus, a destination apparatus and at least one intermediate apparatus, said source apparatus being operable to transmit information in a communication direction towards the destination apparatus either directly along a single communication link or indirectly along a communication path via the or each intermediate apparatus, and the or each intermediate apparatus being operable to receive information from a previous communication apparatus along said path in said communication direction and to transmit the received information to a subsequent apparatus along said path in said communication direction, the method comprising: for a potential communication link between a particular said intermediate apparatus and another apparatus of the communication system, establishing whether said other apparatus is of a first type or of a second type different from said first type; determining whether said link is suitable for communication in a first mode or in a second mode in dependence upon the established type of said other apparatus; and if it is determined that said potential link is suitable for communication in said first mode, concluding a link initiation process in order to enable communication in said first mode along that link.

### INTRODUCTION

Currently there exists significant interest in the use of multihop techniques in packet based radio and other communication systems, where it is purported that such techniques will enable both extension in coverage range and increase in system capacity (throughout).

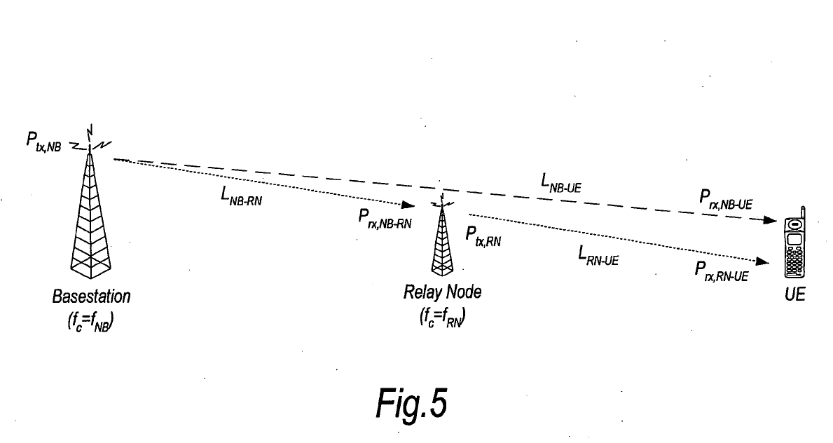

In a multi-hop communication system, communication signals are sent in a communication direction along a communication path (C) from a source apparatus to a destination apparatus via one or more intermediate apparatuses. FIG. 5 illustrates a single-cell two-hop wireless communication system comprising a base station BS (known in the context of 3 G communication systems as “node-B” NB) a relay node RN (also known as a relay station RS) and a user equipment UE (also known as mobile station MS). In the case where signals are being transmitted on the downlink (DL) from a base station to a destination user equipment (UE) via the relay node (RN), the base station comprises the source station (S) and the user equipment comprises the destination station (D). In the case where communication signals are being transmitted on the uplink (UL) from a user equipment (UE), via the relay node, to the base station, the user equipment comprises the source station and the base station comprises the destination station. The relay node is an example of an intermediate apparatus (I) and comprises: a receiver, operable to receive data from the source apparatus; and a transmitter, operable to transmit this data, or a derivative thereof, to the destination apparatus.

Simple analogue repeaters or digital repeaters have been used as relays to improve or provide coverage in dead spots. They can either operate in a different transmission frequency band from the source station to prevent interference between the source transmission and the repeater transmission, or they can operate at a time when there is no transmission from the source station.

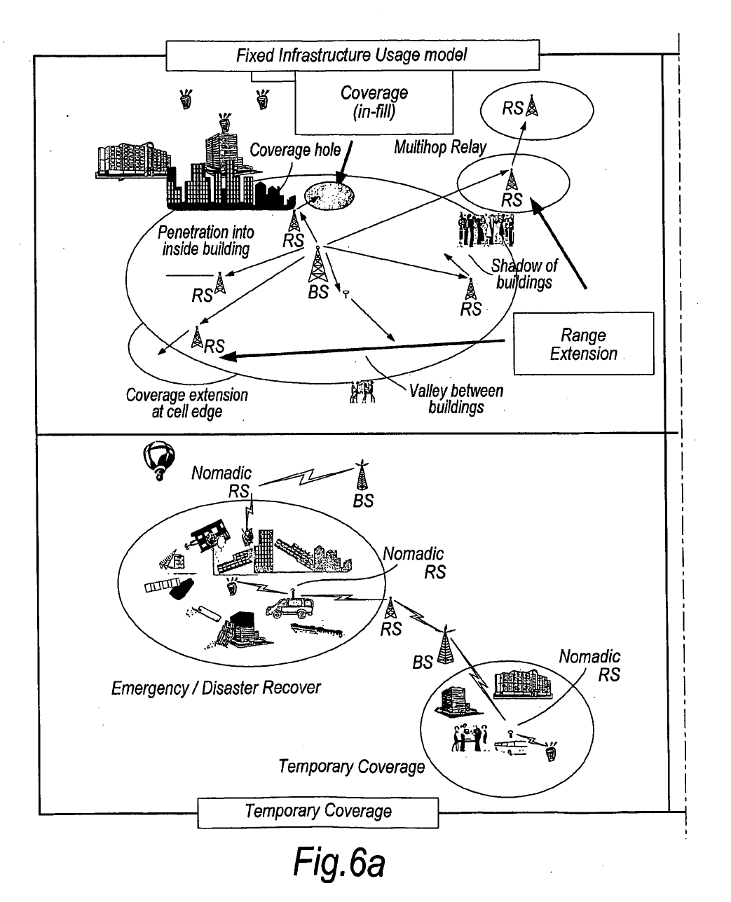

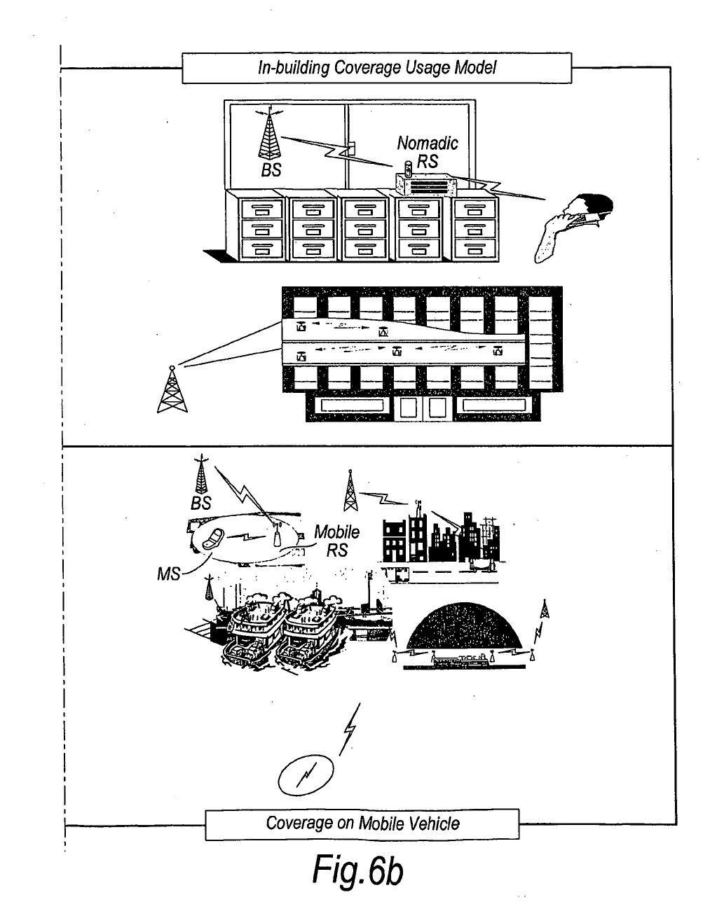

FIG. 6 illustrates a number of applications for relay stations. For fixed infrastructure, the coverage provided by a relay station may be “in-fill” to allow access to the communication network for mobile stations which may otherwise be in the shadow of other objects or otherwise unable to receive a signal of sufficient strength from the base station despite being within the normal range of the base station. “Range extension” is also shown, in which a relay station allows access when a mobile station is outside the normal data transmission range of a base station. One example of in-fill shown at the top right of FIG. 6 is positioning of a nomadic relay station to allow penetration of coverage within a building that could be above, at, or below ground level.

Other applications are nomadic relay stations which are brought into effect for temporary cover, providing access during events or emergencies/disasters. A final application shown in the bottom right of FIG. 6 provides access to a network using a relay positioned on a vehicle.

Relays may also be used in conjunction with advanced transmission techniques to enhance gain of the communications system as explained below.

It is known that the occurrence of propagation loss, or “pathloss”, due to the scattering or absorption of a radio communication as it travels through space, causes the strength of a signal to diminish. Factors which influence the pathloss between a transmitter and a receiver include: transmitter antenna height, receiver antenna height, carrier frequency, clutter type (urban, sub-urban, rural), details of morphology such as height, density, separation, terrain type (hilly, flat). The pathloss L (dB) between a transmitter and a receiver can be modelled by:

L=b+10n log d (A)

Where d (metres) is the transmitter-receiver separation, b(db) and n are the pathloss parameters and the absolute pathloss is given by l=10^{(L/10)}.

The sum of the absolute path losses experienced over the indirect link SI+ID may be less than the pathloss experienced over the direct link SD. In other words it is possible for:

L(SI)+L(ID)<L(SD) (B)

Splitting a single transmission link into two shorter transmission segments therefore exploits the non-linear relationship between pathloss verses distance. From a simple theoretical analysis of the pathloss using equation (A), it can be appreciated that a reduction in the overall pathloss (and therefore an improvement, or gain, in signal strength and thus data throughput) can be achieved if a signal is sent from a source apparatus to a destination apparatus via an intermediate apparatus (e.g. relay node), rather than being sent directly from the source apparatus to the destination apparatus. If implemented appropriately, multi-hop communication systems can allow for a reduction in the transmit power of transmitters which facilitate wireless transmissions, leading to a reduction in interference levels as well as decreasing exposure to electromagnetic emissions. Alternatively, the reduction in overall pathloss can be exploited to improve the received signal quality at the receiver without an increase in the overall radiated transmission power required to convey the signal.

Multi-hop systems are suitable for use with multi-carrier transmission. In a multi-carrier transmission system, such as FDM (frequency division multiplex), OFDM (orthogonal frequency division multiplex) or DMT (discrete multi-tone), a single data stream is modulated onto N parallel sub-carriers, each sub-carrier signal having its own frequency range. This allows the total bandwidth (i.e. the amount of data to be sent in a given time interval) to be divided over a plurality of sub-carriers thereby increasing the duration of each data symbol. Since each sub-carrier has a lower information rate, multi-carrier systems benefit from enhanced immunity to channel induced distortion compared with single carrier systems. This is made possible by ensuring that the transmission rate and hence bandwidth of each subcarrier is less than the coherence bandwidth of the channel. As a result, the channel distortion experienced on a signal subcarrier is frequency independent and can hence be corrected by a simple phase and amplitude correction factor. Thus the channel distortion correction entity within a multicarrier receiver can be of significantly lower complexity of its counterpart within a single carrier receiver when the system bandwidth is in excess of the coherence bandwidth of the channel.

Orthogonal frequency division multiplexing (OFDM) is a modulation technique that is based on FDM. An OFDM system uses a plurality of sub-carrier frequencies which are orthogonal in a mathematical sense so that the sub-carriers' spectra may overlap without interference due to the fact they are mutually independent. The orthogonality of OFDM systems removes the need for guard band frequencies and thereby increases the spectral efficiency of the system. OFDM has been proposed and adopted for many wireless systems. It is currently used in Asymmetric Digital Subscriber Line (ADSL) connections, in some wireless LAN applications (such as WiFi devices based on the IEEE802.11 a/g standard), and in wireless MAN applications such as WiMAX (based on the IEEE 802.16 standard). OFDM is often used in conjunction with channel coding, an error correction technique, to create coded orthogonal FDM or COFDM. COFDM is now widely used in digital telecommunications systems to improve the performance of an OFDM based system in a multipath environment where variations in the channel distortion can be seen across both subcarriers in the frequency domain and symbols in the time domain. The system has found use in video and audio broadcasting, such as DVB and DAB, as well as certain types of computer networking technology.

In an OFDM system, a block of N modulated parallel data source signals is mapped to N orthogonal parallel sub-carriers by using an Inverse Discrete or Fast Fourier Transform algorithm (IDFT/IFFT) to form a signal known as an “OFDM symbol” in the time domain at the transmitter. Thus, an “OFDM symbol” is the composite signal of all N sub-carrier signals. An OFDM symbol can be represented mathematically as:

$$x ( t ) = \frac{1}{\sqrt{N}} {\sum }_{n = 0}^{N - 1} {c}_{n} \cdot {e}^{j 2 π n Δ f t} , 0 \leq t \leq {T}_{s} \qquad ( 1 )$$

where Δf is the sub-carrier separation in Hz, Ts=1/Δf is symbol time interval in seconds, and cₙ are the modulated source signals. The sub-carrier vector in (1) onto which each of the source signals is modulated cεE Cₙ, c=(c₀, c₁ . . . c_{N-1}) is a vector of N constellation symbols from a finite constellation. At the receiver, the received time-domain signal is transformed back to frequency domain by applying Discrete Fourier Transform (DFT) or Fast Fourier Transform (FFT) algorithm.

OFDMA (Orthogonal Frequency Division Multiple Access) is a multiple access variant of OFDM. It works by assigning a subset of sub-carriers, to an individual user. This allows simultaneous transmission from several users leading to better spectral efficiency. However, there is still the issue of allowing bi-directional communication, that is, in the uplink and download directions, without interference.

In order to enable bi-directional communication between two nodes, two well known different approaches exist for duplexing the two (forward or download and reverse or uplink) communication links to overcome the physical limitation that a device cannot simultaneously transmit and receive on the same resource medium. The first, frequency division duplexing (FDD), involves operating the two links simultaneously but on different frequency bands by subdividing the transmission medium into two distinct bands, one for forward link and the other for reverse link communications. The second, time division duplexing (TDD), involves operating the two links on the same frequency band, but subdividing the access to the medium in time so that only the forward or the reverse link will be utilizing the medium at any one point in time. Both approaches (TDD & FDD) have their relative merits and are both well used techniques for single hop wired and wireless communication systems. For example the IEEE802.16 standard incorporates both an FDD and TDD mode.

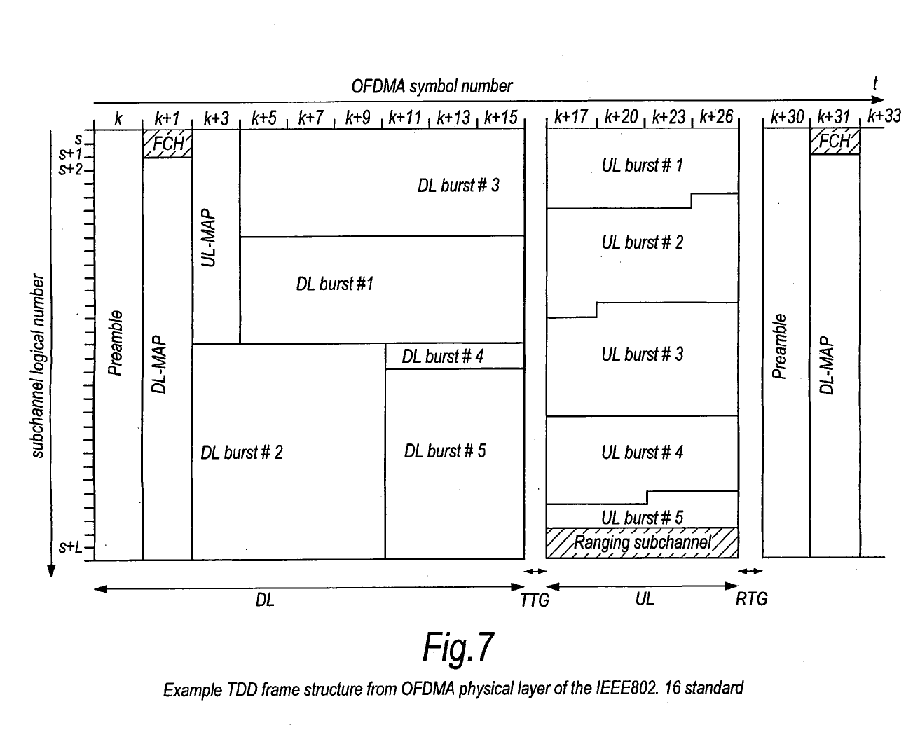

As an example, FIG. 7 illustrates the single hop TDD frame structure used in the OFDMA physical layer mode of the IEEE802.16 standard (WiMAX).

Each frame is divided into DL and UL subframes, each being a discrete transmission interval. They are separated by Transmit/Receive and Receive/Transmit Transition Guard interval (TTG and RTG respectively). Each DL subframe starts with a preamble followed by the Frame Control Header (FCH), the DL-MAP, and the UL-MAP.

The FCH contains the DL Frame Prefix (DLFP) to specify the burst profile and the length of the DL-MAP. The DLFP is a data structure transmitted at the beginning of each frame and contains information regarding the current frame; it is mapped to the FCH.

Simultaneous DL allocations can be broadcast, multicast and unicast and they can also include an allocation for another BS rather than a serving BS. Simultaneous ULs can be data allocations and ranging or bandwidth requests.

This patent application is one of a set of ten UK patent applications filed on the same date by the same applicant with agent reference numbers P106752 GB00, P106753 GB00, P106754 GB00, P106772 GB00, P106773 GB00, P106795 GB00, P106796 GB00, P106797 GB00, P106798 GB00, and P106799 GB00, describing interrelated inventions proposed by the present inventors relating to communication techniques. The entire contents of each of the other nine applications is incorporated herein by way of reference thereto and copies of each of the other nine applications are filed herewith.

In legacy single hop systems (e.g. 802.16-2004 and 802.16e-2005), standard network entry procedures already exist for an MS entering a network. However, as there is no concept of an RS in these systems, no suitable network entry procedure is defined. Embodiments of the invention are suitable as a standard network entry algorithm in the case that it is an RS entering the network.

The invention is defined in the independent claims, to which reference should now be made. Advantageous embodiments are set out in the sub claims.

Preferred features of the present invention will now be described, purely by way of example, with reference to the accompanying drawings, in which:—

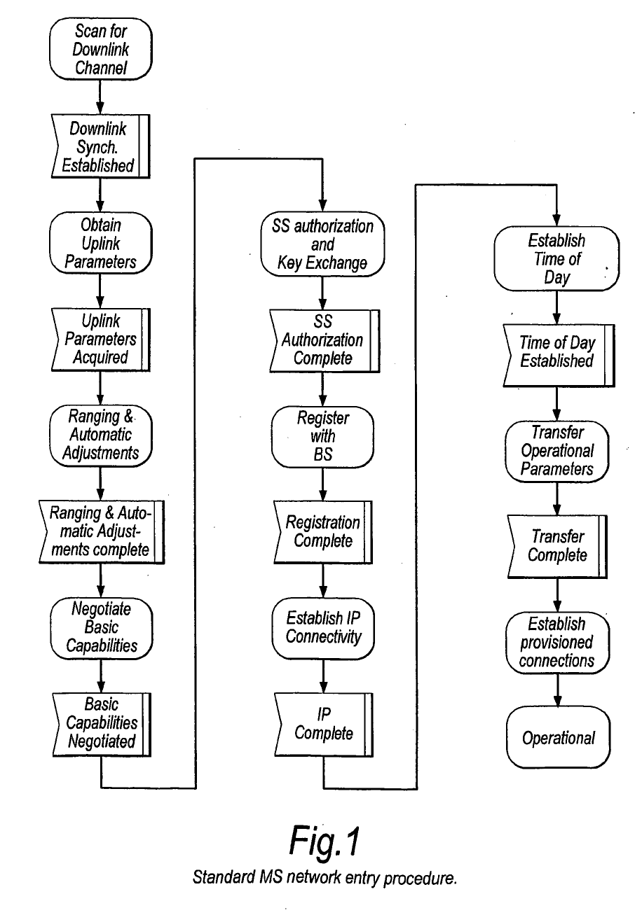

FIG. 1 shows Standard MS network entry procedure;

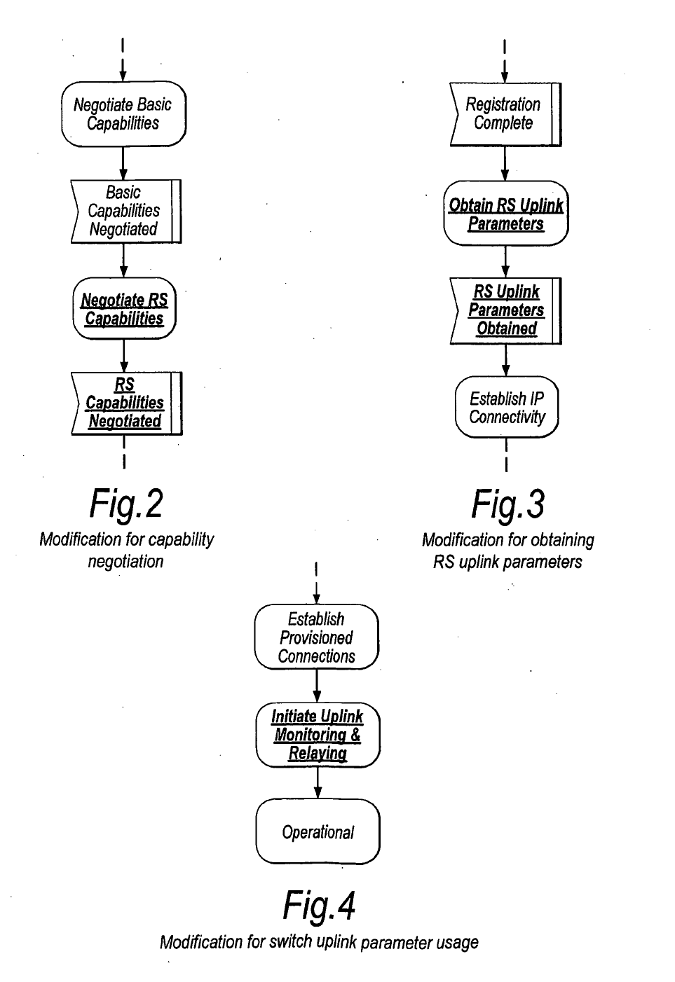

FIG. 2 shows Modification for capability negotiation;

FIG. 3 shows Modification for obtaining RS uplink parameters;

FIG. 4 shows Modification for switch uplink parameter usage;

FIG. 5 shows a single-cell two-hop wireless communication system;

FIG. 6 shows applications of relay stations; and

FIG. 7 shows a single hop TDD frame structure used in the OFDMA physical layer mode of the IEEE 802.16 standard.

### RS NETWORK ENTRY PROCEDURE

The first stage is for the RS to follow the standard MS network entry procedure in order to establish a connection with the BS. An example of the network entry procedure for the case of the 802.16 system is given in Section 6.3.9 of the standard. FIG. 1 summarises these procedures that are detailed further in the standard.

Throughout it is assumed that the network could consist of some legacy BS and some relaying enabled BS. It is also assumed that a relaying enabled BS may be operating in a legacy mode until it receives a request from an RS for it to enter the network. The reason the BS may operate in such a mode would be to preserve transmission resources by not having to broadcast relay specific information when there are no relays benefiting from the transmission.

The first modification to the sequence above is that during the negotiation of basic capabilities the RS will identify itself as an RS to the BS using a new signalling entity (referred to as a TLV) that indicates that the device registering has the capability to act as a relay. Amongst other parameters the relay shall identify its capability to act as a relay on DL and/or UL traffic. It shall also declare the type of relaying supported (i.e. transparent or not). The required processes that need to be included into the procedure shown in FIG. 1 are shown in FIG. 2 in underlined text.

As a result, the BS will now know that the connecting device is an RS, if it completes this stage. If the BS is a legacy BS then it will not complete this stage as it will not acknowledge the use of the extended relay related capabilities. However the RS may continue the network entry procedure as it may be able to operate in an alternative mode that does not require the BS to have knowledge that it is a RS and not an MS.

If the RS is to perform uplink relaying (as identified above) then the second modification is that at some point between the RS becoming successfully registered with the BS and the RS becoming operational it will require the BS to inform it of the RS specific uplink parameters. In particular, this is required as during the normal ranging region, the RS will have to be receiving signals from MS or other RS and hence cannot be transmitting to the BS.

It is assumed that if the BS is not already advertising these parameters through an appropriate message, it will at least start once it is aware that an RS is entering the network as determined during the RS capability negotiation stage. Therefore if the RS cannot determine the RS specific uplink parameters because they are not being advertised by the BS (usually after a timeout period of waiting for the parameters to be broadcast) it will assume that the BS does not support RSs (i.e. it is a legacy BS) and will mark the downlink channel associated with this BS as unusuable and restart the network entry procedure scanning for other potential downlink channels.

The required processes that need to be included into the procedure shown in FIG. 1 are shown in FIG. 3 in underlined text.

Once the RS uplink parameters are identified the RS then switches to using these new parameters on the uplink prior to becoming operational. This is required before the RS is operational and is the final amendment required to the procedure shown in FIG. 1, as shown in FIG. 4 in underlined text.

The RS completes the network entry procedure and now becomes operational, receiving the preamble to maintain synchronisation and the DL and UL-MAP messages to understand the allocation of resources within the frame for communication with the MS and BS.

### Extension for the Case of RS Transmitting a Preamble

If the RS is required to provide transmission of broadcast control information (i.e. the MS cannot receive this information directly from the BS or RS to which the RS is connecting) then prior to becoming operational one final step is required. In this case, the BS or RS will have identified to the RS during the capability negotiating phase that the RS should operate in such a mode. The RS will then stop listening to the normal preamble and MAP messages, so that it can transmit its own. Instead, it will ascertain from the BS or RS to which it is connecting the location of the relay amble, or other RS specific information signal that can be used to identify the transmitter and train the various distortion correction units within the receiver in the absence of the preamble knowledge.

At this point the RS can then begin to broadcast the normal preamble and as and when required, the MAP messages.

During operation the RS continually monitors the RS uplink parameters and other RS specific information signals on the downlink (i.e. Relay Amble and control information) as the BS or RS may change these based on the dynamically changing operational environment. For example, as more uplink channels are required to report HARQ related ACK/NACKs, channel quality reports or increase the ranging region.

### Benefits

In summary the benefits of invention embodiments are:
Defines a simple modification to an existing procedure that supports the entry of both MS and RS into a communication network.
Minimises the impact on existing BS designs as the number of modifications required are minimal.
Enables the RS to closely mimic the procedure already developed and in use in the MS, thus enabling reuse of existing software developed to support network entry procedures in the MS.

Embodiments of the present invention may be implemented in hardware, or as software modules running on one or more processors, or on a combination thereof.

That is, those skilled in the art will appreciate that a microprocessor or digital signal processor (DSP) may be used in practice to implement some or all of the functionality of a transmitter embodying the present invention. The invention may also be embodied as one or more device or apparatus programs (e.g. computer programs and computer program products) for carrying out part or all of any of the methods described herein. Such programs embodying the present invention may be stored on computer-readable media, or could, for example, be in the form of one or more signals. Such signals may be data signals downloadable from an Internet website, or provided on a carrier signal, or in any other form.

1. A method of assessing a potential communication link in a wireless communication system, the system comprising a source apparatus, a destination apparatus and at least one intermediate apparatus, said source apparatus being operable to transmit information in a communication direction towards the destination apparatus either directly along a single communication link or indirectly along a communication path via the or each intermediate apparatus, and the or each intermediate apparatus being operable to receive information from a previous communication apparatus along said path in said communication direction and to transmit the received information to a subsequent apparatus along said path in said communication direction, the method comprising:
for a potential communication link between a particular said intermediate apparatus and another apparatus of the communication system, establishing whether said other apparatus is of a first type or of a second type different from said first type;
determining whether said link is suitable for communication in a first mode or in a second mode in dependence upon the established type of said other apparatus; and
if it is determined that said potential link is suitable for communication in said first mode, concluding a link initiation process in order to enable communication in said first mode along that link.

2. The method according to claim 1, wherein communication in said first mode involves use of a set of capabilities of the particular intermediate apparatus, and wherein communication in said second mode involves use of a subset of said set of capabilities of the particular intermediate apparatus.

3. The method according to claim 2, comprising:
if it is determined that said link is suitable for communication in said second mode, concluding a link initiation process in order to enable communication in said second mode along that potential link.

4. The method according to claim 1, wherein communication in said first mode involves use of some or all of a set of capabilities of the particular intermediate apparatus, and wherein communication in said second mode does not allow conclusion of a link initiation process for the potential link, so that if it is determined that said potential link is suitable for communication in said second mode, the potential link is preferably marked as unusable.

5. The method according to any preceding claim, comprising carrying out said establishing in said other apparatus.

6. The method according to any preceding claim, comprising carrying out said establishing in the particular intermediate apparatus.

7. The method according to claim 6, comprising carrying out said establishing based upon information received from said other apparatus.

8. The method according to claim 6 or 7, comprising carrying out said establishing based upon information received from another apparatus of the system.

9. The method according to any one of claims 6 to 8, comprising carrying out said establishing based upon information stored within the particular intermediate apparatus.

10. The method according to any preceding claim, comprising carrying out said determination in the particular intermediate apparatus.

11. The method according to any preceding claim, further comprising configuring a mode of operation of said particular intermediate apparatus based upon the established type of said other apparatus.

12. The method according to any preceding claim further comprising configuring a communication format for use in communication between the particular intermediate apparatus and said other apparatus based upon the established type of said other apparatus.

13. The method according to any preceding claim, wherein said other apparatus is a previous said apparatus along said path relative to the particular intermediate apparatus, the method further comprising configuring a communication format for use in communication between the particular intermediate apparatus and a subsequent apparatus along said path relative to the particular intermediate apparatus based upon the established type of said other apparatus.

14. The method according to any preceding claim, wherein said other apparatus is said source apparatus.

15. The method according to any one of claims 1 to 13, wherein said other apparatus is said destination apparatus.

16. The method according to any one of claims 1 to 13, wherein said system comprises at least two intermediate apparatuses, and wherein said other apparatus is a said intermediate apparatus other than the particular intermediate apparatus.

17. The method according to any preceding claim, wherein said source apparatus is a base station.

18. The method according to any preceding claim, wherein said source apparatus is a mobile terminal.

19. The method according to any preceding claim, wherein said destination apparatus is a base station.

20. The method according to any preceding claim, wherein said destination apparatus is a mobile terminal.

21. The method according to any preceding claim, wherein the or each intermediate apparatus is a relay station.

22. The method according to any preceding claim, wherein the system is an OFDM or OFDMA communication system.

23. A wireless communication system, comprising:
a source apparatus, a destination apparatus and at least one intermediate apparatus, said source apparatus being operable to transmit information in a communication direction towards the destination apparatus either directly along a single communication link or indirectly along a communication path via the or each intermediate apparatus, and the or each intermediate apparatus being operable to receive information from a previous communication apparatus along said path in said communication direction and to transmit the received information to a subsequent apparatus along said path in said communication direction;
establishing means operable, for a potential communication link between a particular said intermediate apparatus and another apparatus of the communication system, to establish whether said other apparatus is of a first type or of a second type different from said first type;
determining means operable to determine whether said link is suitable for communication in a first mode or in a second mode in dependence upon the established type of said other apparatus; and
concluding means operable, if it is determined that said potential link is suitable for communication in said first mode, to conclude a link initiation process in order to enable communication in said first mode along that link.

24. A computer program which, when executed on a computing device of a wireless communication system, causes the system to carry out a method of assessing a potential communication link, the system comprising a source apparatus, a destination apparatus and at least one intermediate apparatus, said source apparatus being operable to transmit information in a communication direction towards the destination apparatus either directly along a single communication link or indirectly along a communication path via the or each intermediate apparatus, and the or each intermediate apparatus being operable to receive information from a previous communication apparatus along said path in said communication direction and to transmit the received information to a subsequent apparatus along said path in said communication direction, the method comprising:
for a potential communication link between a particular said intermediate apparatus and another apparatus of the communication system, establishing whether said other apparatus is of a first type or of a second type different from said first type;
determining that said link is suitable for communication in a first mode or in a second mode in dependence upon the established type of said other apparatus; and
if it is determined that said potential link is suitable for communication in said first mode, commencing a link initiation process in order to enable communication in said first mode along that link.

25. An intermediate apparatus for use in a wireless communication system, the system further comprising:
a source apparatus and a destination apparatus, said source apparatus being operable to transmit information in a communication direction towards the destination apparatus either directly along a single communication link or indirectly along a communication path via the intermediate apparatus, and the intermediate apparatus being operable to receive information from a previous communication apparatus along said path in said communication direction and to transmit the received information to a subsequent apparatus along said path in said communication direction, the intermediate apparatus comprising:
establishing means operable, for a potential communication link between the intermediate apparatus and another apparatus of the communication system, to establish whether said other apparatus is of a first type or of a second type different from said first type;
determining means operable to determine whether said link is suitable for communication in a first mode or in a second mode in dependence upon the established type of said other apparatus; and
concluding means operable, if it is determined that said potential link is suitable for communication in said first mode, to conclude a link initiation process in order to enable communication in said first mode along that link.
